(19) United States
(12) Patent Application Publication
(10) Pub. No.: US 2022/0231952 A1
(43) Pub. Date: Jul. 21, 2022

(54) OPTIMAL SELECTION OF A CLOUD-BASED DATA MANAGEMENT SERVICE FOR IoT SENSORS

(71) Applicant: Cisco Technology, Inc., San Jose, CA (US)

(72) Inventors: Robert E. Barton, Richmond (CA); Elango Ganesan, Palo Alto, CA (US); Jerome Henry, Pittsboro, NC (US)

(21) Appl. No.: 17/153,440

(22) Filed: Jan. 20, 2021

(51) Int. Cl. H04L 12/801; H04L 12/26

(52) U.S. Cl. CPC H04L 47/15; G16Y 30/00; H04L 43/062; H04L 43/12

(57) ABSTRACT

In one embodiment, a first device coordinates probing of network paths that extend between an edge device and a data collection point via a plurality of points of presence. The first device receives a set of probing results that are indicative of one or more performance metrics associated with the network paths. The first device selects, based on the set of probing results, a particular point of presence from among the plurality of points of presence through which the edge device should send traffic to the data collection point. The first device instructs the edge device to send traffic to the data collection point via the particular point of presence.

### TECHNICAL FIELD

The present disclosure relates generally to computer networks, and, more particularly, to the optimal selection of a cloud-based management service for Internet of Things (IoT) sensors.

### BACKGROUND

The Internet of Things, or “IoT” for short, represents an evolution of computer networks that seeks to connect many everyday objects to the Internet. Notably, there has been a recent proliferation of ‘smart’ devices that are Internet-capable such as thermostats, lighting, televisions, cameras, and the like. In many implementations, these devices may also communicate with one another. For example, an IoT motion sensor may communicate with one or more smart lightbulbs, to actuate the lighting in a room when a person enters the room. Vehicles are another class of ‘things’ that are being connected via the IoT for purposes of sharing sensor data, implementing self-driving capabilities, monitoring, and the like.

As the IoT evolves, the variety of IoT devices will continue to grow, as well as the number of applications associated with the IoT devices. For instance, multiple cloud-based, business intelligence (BI) applications may take as input measurements captured by a particular IoT sensor. To this end, data pipelines are often constructed from the edge device(s) of the IoT network to the destination cloud provider. Typically, the nearest point of presence (POP) is selected, without regard to the overall destination of the sensor data.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrate an example network;

FIG. 2 illustrates an example network device/node;

FIG. 3 illustrates an example network architecture for edge to multi-cloud processing and governance;

FIGS. 4A-4B illustrate examples of data processing by an edge device in a network;

FIGS. 5A-5G illustrates an example of the selection of a point of presence (POP); and

FIG. 6 illustrates an example simplified procedure for selecting an optimal POP.

### DESCRIPTION OF EXAMPLE EMBODIMENTS

### Overview

According to one or more embodiments of the disclosure, a first device coordinates probing of network paths that extend between an edge device and a data collection point via a plurality of points of presence. The first device receives a set of probing results that are indicative of one or more performance metrics associated with the network paths. The first device selects, based on the set of probing results, a particular point of presence from among the plurality of points of presence through which the edge device should send traffic to the data collection point. The first device instructs the edge device to send traffic to the data collection point via the particular point of presence.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

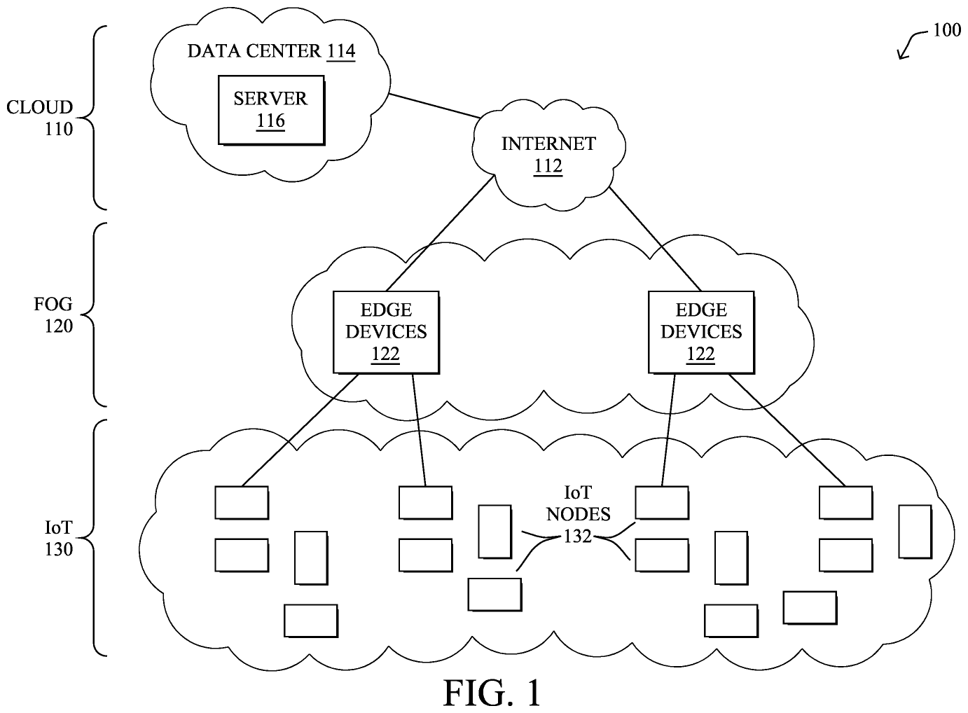

FIG. 1 is a schematic block diagram of an example simplified computer network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example IoT network 100, three illustrative layers are shown, namely cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices 122 may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), PLC protocols, or other shared-media protocols where appropriate. In this context, a protocol consists of a set of rules defining how the nodes interact with each other.

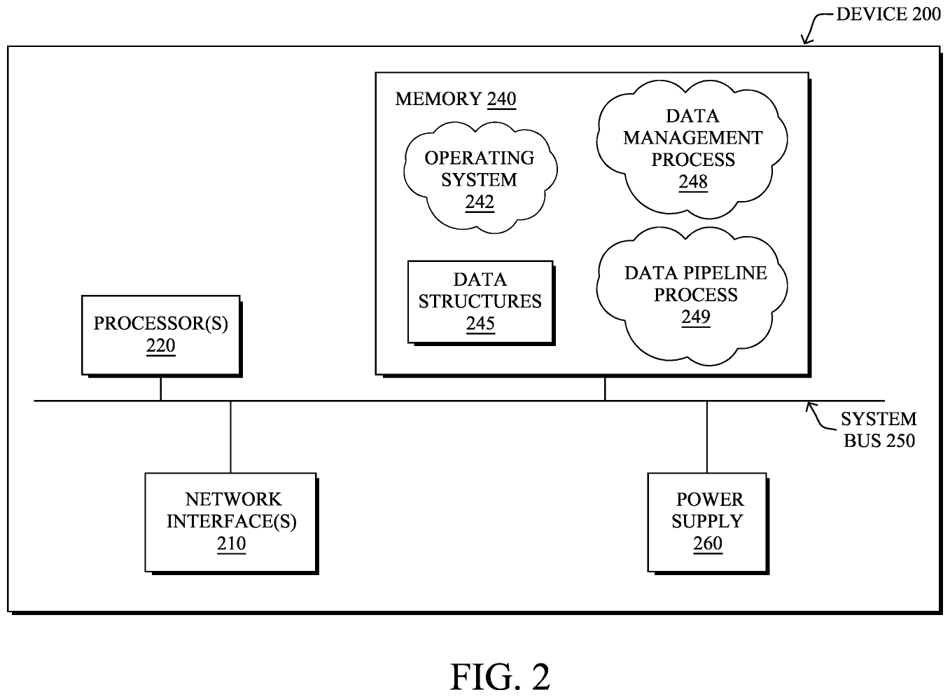

FIG. 2 is a schematic block diagram of an example node/device 200 that may be used with one or more embodiments described herein, e.g., as any of the nodes or devices shown in FIG. 1 above or described in further detail below. The device 200 may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative data management process 248 and/or a data pipeline configuration process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

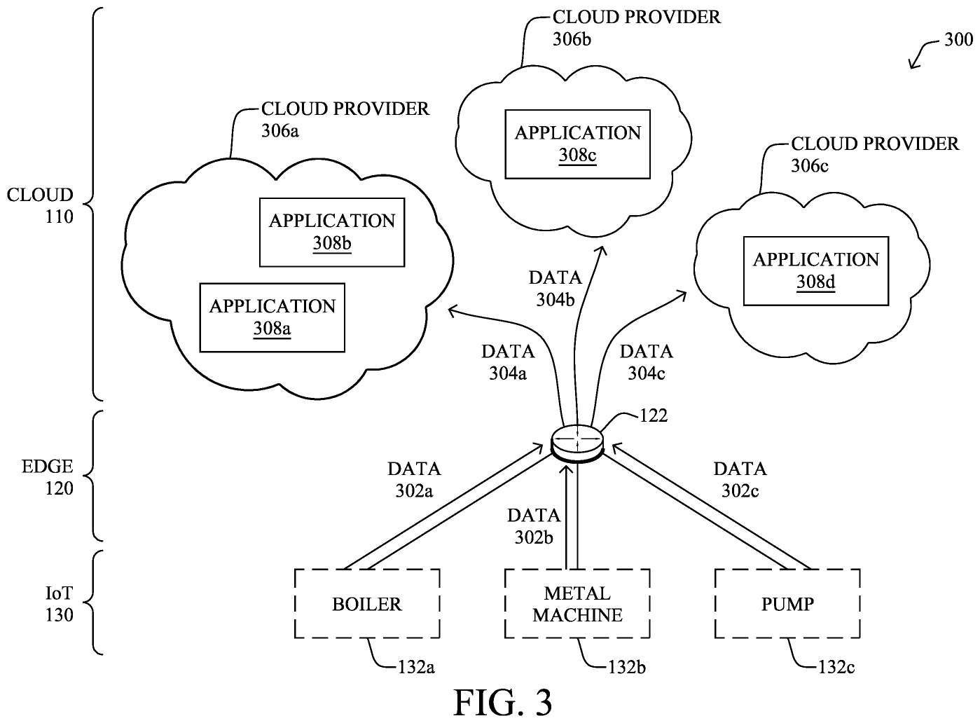

FIG. 3 illustrates an example network architecture 300 for edge to multi-cloud processing and governance, according to various embodiments. As shown, consider the case of an IoT network at IoT layer 130 that comprises a plurality of nodes 132, such as node 132a (e.g., a boiler), node 132b (e.g., a metal machine), and node 132c (e.g., a pump). Notably, the IoT network at IoT layer 130 may comprise any numbers of sensors and/or actuators. For instance, the network may be located in an industrial setting, such as a factory, port, substation, or the like, a smart city, a stadium, a conference or office building, or any other location in which IoT devices may be deployed.

As noted above, as the IoT evolves, the variety of IoT devices will continue to grow, as well as the number of applications associated with the IoT devices. As a result, multiple cloud-based applications may take as input measurements or other data generated by a particular IoT device/node. For instance, as shown, assume that IoT nodes 132a-132c generate data 302a-302c, respectively, for consumption by any number of applications 308 hosted by different cloud providers 306, such as Microsoft Azure, Software AG, Quantela, MQTT/DC, or the like.

To complicate the collection and distribution of data 302a-302c, the different applications 308 may also require different sets of data 304a-304c from data 302a-302c. For instance, assume that cloud provider 306a hosts application 308a, which is a monitoring application used by the operator of the IoT network. In addition, cloud provider 306a may also host application 308b, which is a developer application that allows the operator of the IoT network to develop and deploy utilities and configurations for the IoT network. Another application, application 308c, may be hosted by an entirely different cloud provider 306b and be used by the vendor or manufacturer of a particular IoT node 132 for purposes. Finally, a further application, application 308d, may be hosted by a third cloud provider 306c, which is used by technicians for purposes of diagnostics and the like.

From the standpoint of the edge device 122, such as a router or gateway at the edge of the IoT network, the lack of harmonization between data consumers can lead to overly complicated data access policies, virtual models of IoT nodes 132 (e.g., ‘device twins’ or ‘device shadows’) that are often not portable across cloud providers 306, and increased resource consumption. In addition, different IoT nodes may communicate using different protocols within the IoT network. For instance, IoT nodes 132a-132c may communicate using MQTT, Modbus, OPC Unified Architecture (OPC UA), combinations thereof, or other existing communication protocols that are typically used in IoT networks. As a result, the various data pipelines must be configured on an individual basis at edge device 122 and for each of the different combinations of protocols and destination cloud providers 306.

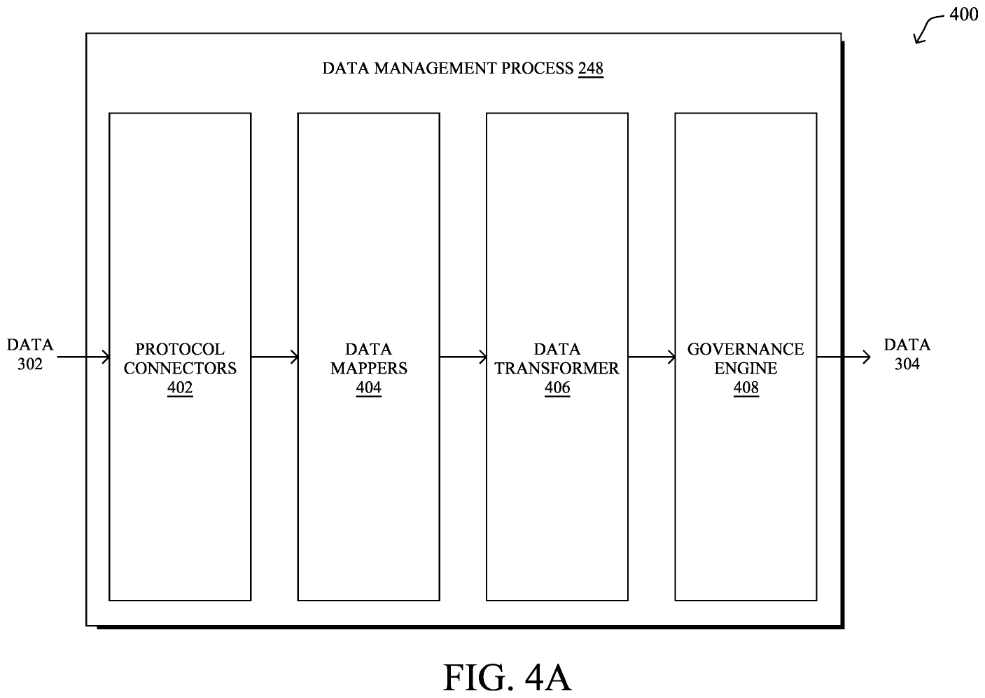

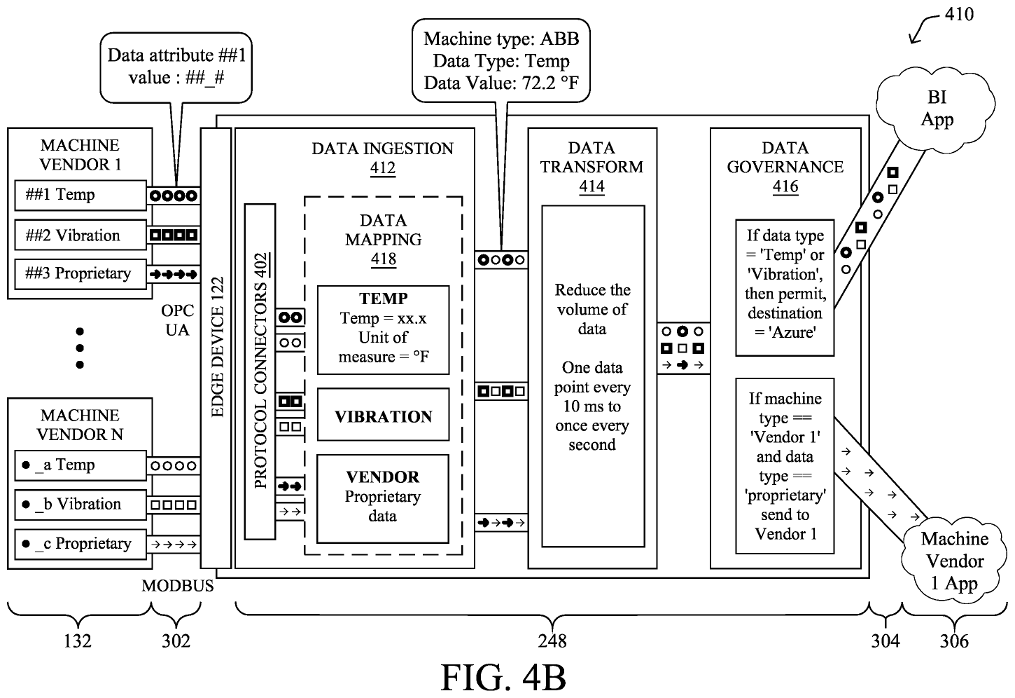

FIG. 4A illustrates an example architecture 400 for data management process 248, according to various embodiments. As shown, data management process 248 may comprise any or all of the following components: a plurality of protocol connectors 402, data mappers 404, a data transformer 406, and/or a governance engine 408. Typically, these components are executed on a single device located at the edge of the IoT network. However, further embodiments provide for these components to be executed in a distributed manner across multiple devices, in which case the combination of devices can be viewed as a singular device for purposes of the teachings herein. Further, functionalities of the components of architecture 400 may also be combined, omitted, or implemented as part of other processes, as desired.

During execution, protocol connectors 402 may comprise a plurality of southbound connectors that are able to extract data 302 from traffic in the IoT network sent via any number of different protocols. For instance, protocol connectors 402 may include connectors for OPC UA, Modbus, Ethernet/IP, MQTT, and the like. Accordingly, when the device executing data management process 248 (e.g., device 200) receives a message from the IoT network, such as a packet, frame, collection thereof, or the like, protocol connectors 402 may process the message using its corresponding connector to extract the corresponding data 302 from the message.

Once data management process 248 has extracted data 302 from a given message using the appropriate connector in protocol connectors 402, data mappers 404 may process the extracted data 302. More specifically, in various embodiments, data mappers 404 may normalize the extracted data 302. Typically, this may entail identifying the data extracted from the traffic in the network as being of a particular data type and grouping the data extracted from the traffic in the network with other data of the particular data type. In some instances, this may also entail associating a unit of measure with the extracted data 302 and/or converting a data value in one unit of measure to that of another.

In various embodiments, once data 302 has been extracted and normalized, data transformer 406 may apply any number of data transformation to the data. In some embodiments, data transformer 406 may transform data 302 by applying any number of mathematical and/or symbolic operations to it. For instance, data transformer 406 may apply a data compression or data reduction to the extracted and normalized data 302, so as to summarize or reduce the volume of data transmitted to the cloud. To do so, data transformer 406 may sample data 302 over time, compute statistics regarding data 302 (e.g., its mean, median, moving average, etc.), apply a compression algorithm to data 302, combinations thereof, or the like.

In further embodiments, data transformer 406 may apply analytics to the extracted and normalized data 302, so as to transform the data into a different representation, such as an alert or other indication. For instance, data transformer 406 may apply simple heuristics and/or thresholds to data 302, to transform data 302 into an alert. In another embodiment, data transformer 406 may apply machine learning to data 302, to transform the data.

In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

Data transformer 406 may employ one or more supervised, unsupervised, or semi-supervised machine learning models. Generally, supervised learning entails the use of a training set of data that is used to train the model to apply labels to the input data. For example, the training data may include samples of ‘good’ readings or operations and ‘bad’ readings or operations that are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. For instance, an unsupervised model may Semi-supervised learning models take a middle ground approach that uses a greatly reduced set of labeled training data.

Example machine learning techniques that data transformer 406 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, deep learning models, or the like.

In further embodiments, data transformer 406 may comprise a scripting engine that allows developers to deploy any number of scripts to be applied to data 302 for purposes of the functionalities described above. For instance, an application developer may interface with application 308b shown previously in FIG. 3, to develop and push various scripts for execution by data transformer 406, if allowed to do so by policy. In other cases, previously developed scripts may also be pre-loaded into data transformer 406 and/or made available by the vendor or manufacturer of the device executing data management process 248 for deployment to data transformer 406.

According to various embodiments, another potential component of data management process 248 is governance engine 408 that is responsible for sending the data 302 transformed by data transformer 406 to any number of cloud providers as data 304. In general, governance engine 408 may control the sending of data 304 according to a policy. For instance, governance engine 408 may apply a policy that specifies that data 304 may be sent to a particular cloud provider and/or cloud-based application, but should not be sent to others. In some embodiments, the policy enforced by governance engine 408 may control the sending of data 304 on a per-value or per-data type basis. For instance, consider the case of an IoT node reporting a temperature reading and pressure reading. In such a case, governance engine 408 may send the temperature reading to a particular cloud provider as data 304 while restricting the sending of the pressure reading, according to policy.

As would be appreciated, by unifying the policy enforcement via governance engine 408, the various stakeholders in the data pipelines are able to participate in the creation and maintenance of the enforced policies. Today, the various data pipelines built to support the different network protocols and cloud vendors results in a disparate patchwork of policies that require a level of expertise that not every participant may possess. In contrast, by unifying the policy enforcement via governance engine 408, personnel such as security experts, data compliance representatives, technicians, developers, and the like can participate in the administration of the policies enforced by governance engine 408.

FIG. 4B illustrates an example 410 of the operation of data management process 248 during execution, according to various embodiments. As shown, assume that edge device 122 described previously (e.g., a device 200) executes data management process 248 at the edge of an IoT network that comprises IoT nodes 132. During operation, edge device 122 may communicate with IoT nodes 132 in the network that comprise devices from n-number of different vendors.

Each set of vendor devices in IoT nodes 132 may generate different sets of data, such as sensor readings, computations, or the like. For instance, the devices from a first machine vendor may generate data such as a proprietary data value, a temperature reading, and a vibration reading. Similarly, the devices from another machine vendor may generate data such as a temperature reading, a vibration reading, and another data value that is proprietary to that vendor.

As would be appreciated, the data 302 generated from each group of IoT nodes 132 may use different formats that are set by the device vendors or manufacturers. For instance, two machines from different vendors may both report temperature readings, but using different data attribute labels (e.g., “temp=,” “temperature=,” “##1,” “*_a,” etc.). In addition, the actual data values may differ by vendor, as well. For instance, the different temperature readings may report different levels of precision/number of decimals, use different units of measure (e.g., Celsius, Fahrenheit, Kelvin, etc.), etc.

Another way in which data 302 generated by IoT nodes 132 may differ is the network protocol used to convey data 302 in the network. For instance, the devices from one machine vendor may communicate using the OPC UA protocol, while the devices from another machine vendor may communicate using the Modbus protocol.

In response to receiving data 302 from IoT nodes 132, data management process 248 of edge device 122 may process data 302 in three stages: a data ingestion phase 412, a data transformation phase 414, and a data governance phase 416. These three processing phases operate in conjunction with one another to allow edge device 122 to provide data 304 to the various cloud providers 306 for consumption by their respective cloud-hosted applications.

During the data ingestion phase 412, protocol connectors 402 may receive messages sent by IoT nodes 132 in their respective protocols, parse the messages, and extract the relevant data 302 from the messages. For instance, one protocol connector may process OPC UA messages sent by one set of IoT nodes 132, while another protocol connector may process Modbus messages sent by another set of IoT nodes 132. Once protocol connectors 402 have extracted the relevant data 302 from the messages, data management process 248 may apply a data mapping 418 to the extracted data, to normalize the data 302. For instance, data management process 248 may identify the various types of reported data 302 and group them by type, such as temperature measurements, vibration measurements, and vendor proprietary data. In addition, the data mapping 418 may also entail standardizing the data on a particular format (e.g., a particular number of digits, unit of measure, etc.). The data mapping 418 may also entail associating metadata with the extracted data 302, such as the source device type, its vendor, etc.

During its data transformation phase 414, data management process 248 may apply various transformations to the results of the data ingestion phase 412. For instance, assume that one IoT node 132 reports its temperature reading every 10 milliseconds (ms). While this may be acceptable in the IoT network, and even required in some cases, reporting the temperature readings at this frequency to the cloud-providers may represent an unnecessary load on the WAN connection between edge device 122 and the cloud provider(s) 306 to which the measurements are to be reported. Indeed, a monitoring application in the cloud may only need the temperature readings at a frequency of once every second, meaning that the traffic overhead to the cloud provider(s) 306 can be reduced by a factor of one hundred by simply reporting the measurements at one second intervals. Accordingly, data transformation phase 414 may reduce the volume of data 304 sent to cloud provider(s) 306 by sending only a sampling of the temperature readings (e.g., every hundred), an average or other statistic(s) of the temperature readings in a given time frame, or the like.

During its data governance phase 416, data management process 248 may apply any number of different policies to the transformed data, to control how the resulting data 304 is sent to cloud provider(s) 306. For instance, one policy enforced during data governance phase 416 may specify that if the data type=‘Temp’ or ‘Vibration,’ then that data is permitted to be sent to destination=‘Azure,’ for consumption by a BI application hosted by Microsoft Azure. Similarly, another policy may specify that if the machine type=‘Vendor 1’ and the data type=‘proprietary,’ then the corresponding data can be sent to a cloud provider associated with the vendor.

In some embodiments, the policy enforced during data governance phase 416 may further specify how data 304 is sent to cloud providers 306. For instance, the policy may specify that edge device 122 should send data 304 to a particular cloud provider 306 via an encrypted tunnel, using a particular set of one or more protocols (e.g., MQTT), how the connection should be monitored and reported, combinations thereof, and the like.

As noted above, IoT data is increasingly managed by a cloud-based system (e.g., Amazon Web Services IoT Core, Azure IoT Hub, Asset Vision and Edge Intelligence by Cisco Systems, Inc., etc.). In this model, the local IoT network sends data to a cloud data aggregation and brokering service, such as an MQTT broker, a LoRaWAN Network Server, or the like. In turn, that data is then passed back to the desired data repository of the owner of the IoT network, such as a data warehouse or big data system, where the data can be analyzed. Typically, the location of the data consumption service is different than the data warehouse, to which the data is ultimately sent. For example, a network operator may want their data passed to an on-site Hadoop, NoSQL, or Spark system in their data center, to a Google machine learning service, or some other place.

Optimal Selection of a Cloud-Based Data Management Service for IoT Sensors

The techniques introduced herein allow for the optimal selection of a cloud-based point of presence (POP) through which data may be sent from an IoT network to a data collection point. In some aspects, the techniques herein allow for the probing of the various path segments between the IoT network and the data collection point, in a coordinated manner. Based on the probing results, a device can select the optimal POP through which the data from the IoT network should be sent.

Illustratively, the techniques described herein may be performed by hardware, software, and/or firmware, such as in accordance with data management process 248 and/or data pipeline configuration process 249, which may include computer executable instructions executed by the processor 220 (or independent processor of interfaces 210) to perform functions relating to the techniques described herein.

Specifically, in various embodiments, a first device coordinates probing of network paths that extend between an edge device and a data collection point via a plurality of points of presence. The first device receives a set of probing results that are indicative of one or more performance metrics associated with the network paths. The first device selects, based on the set of probing results, a particular point of presence from among the plurality of points of presence through which the edge device should send traffic to the data collection point. The first device instructs the edge device to send traffic to the data collection point via the particular point of presence.

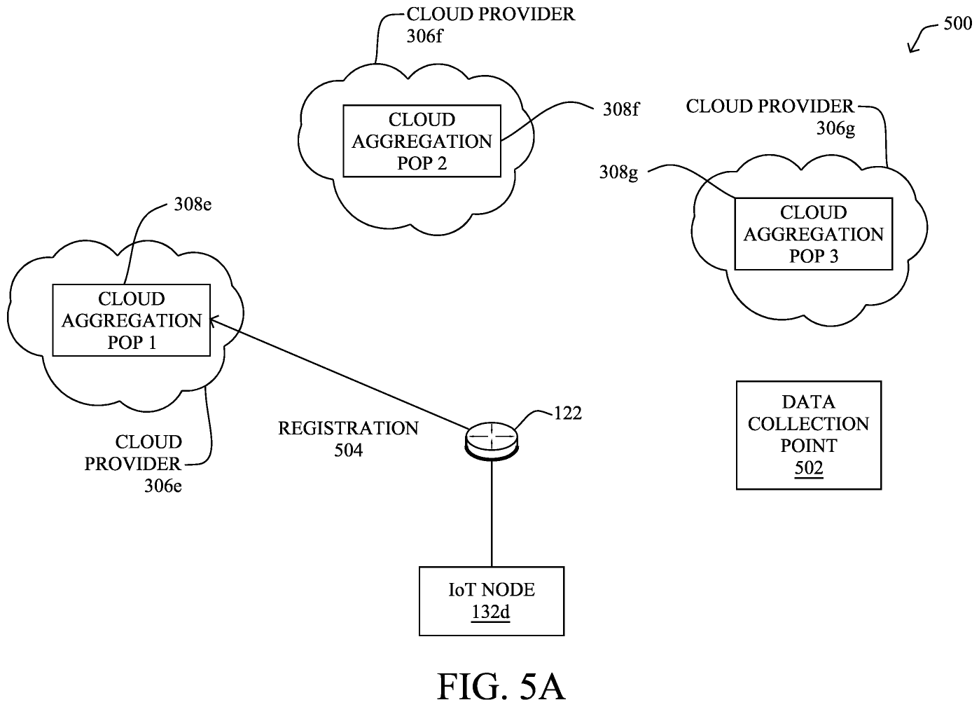

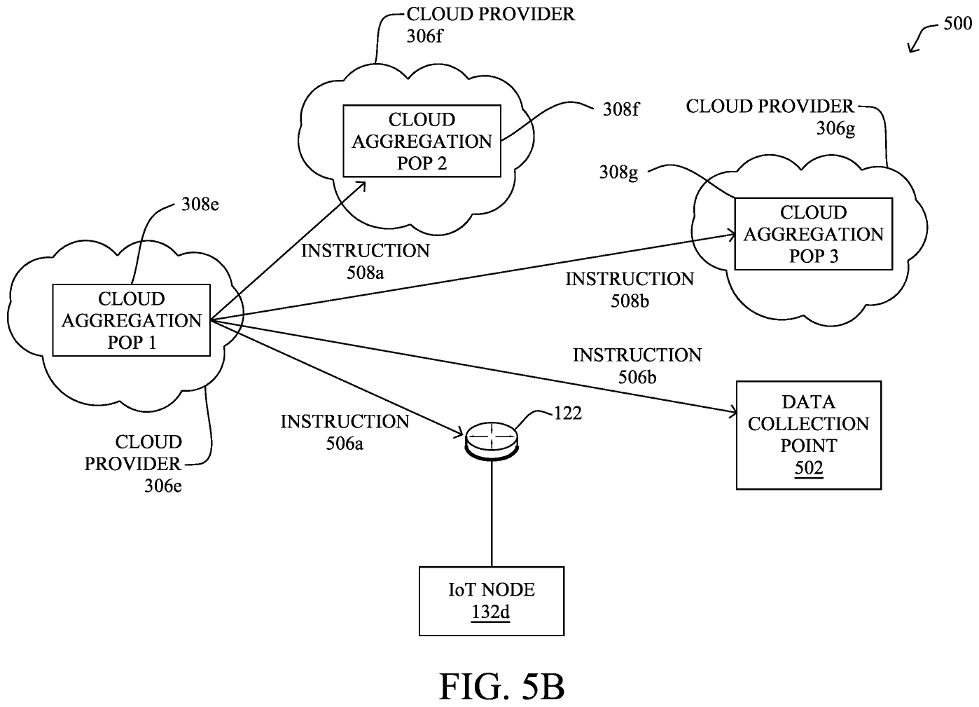

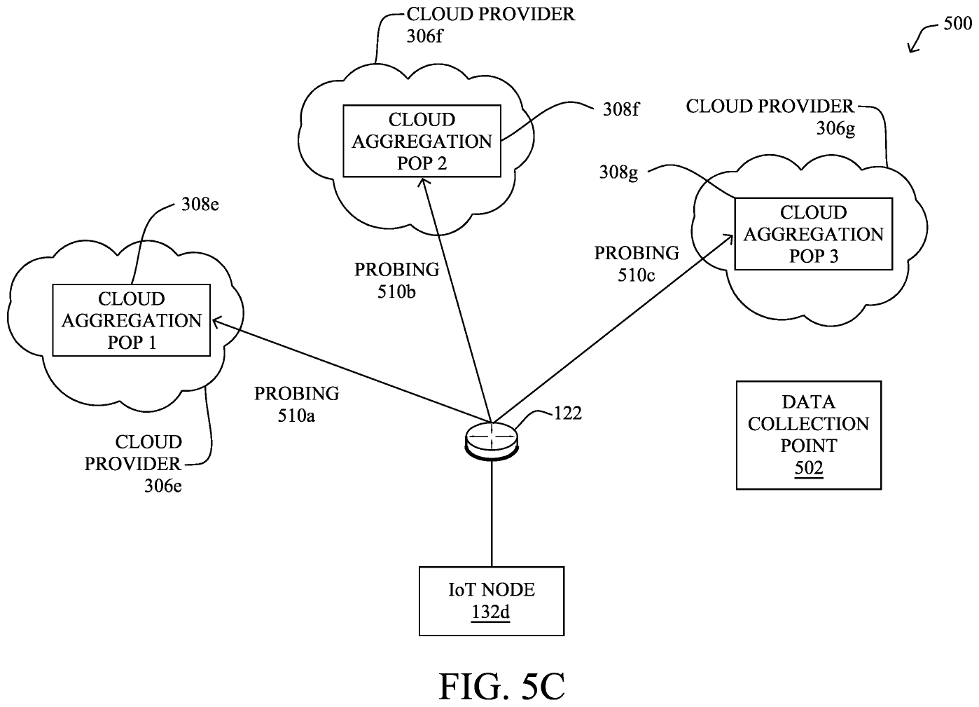

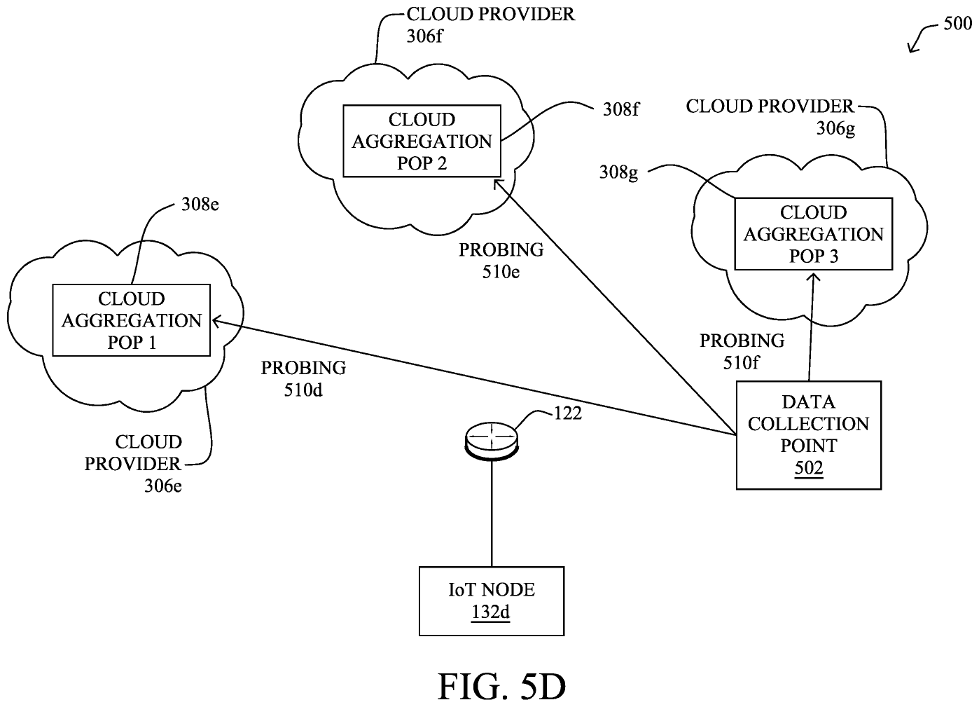

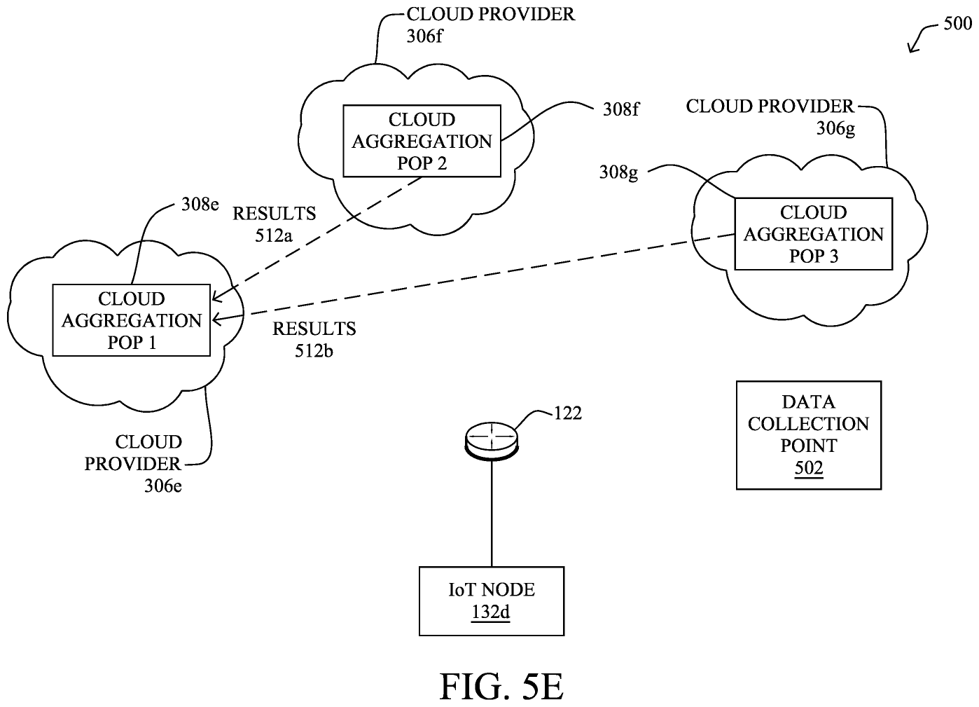

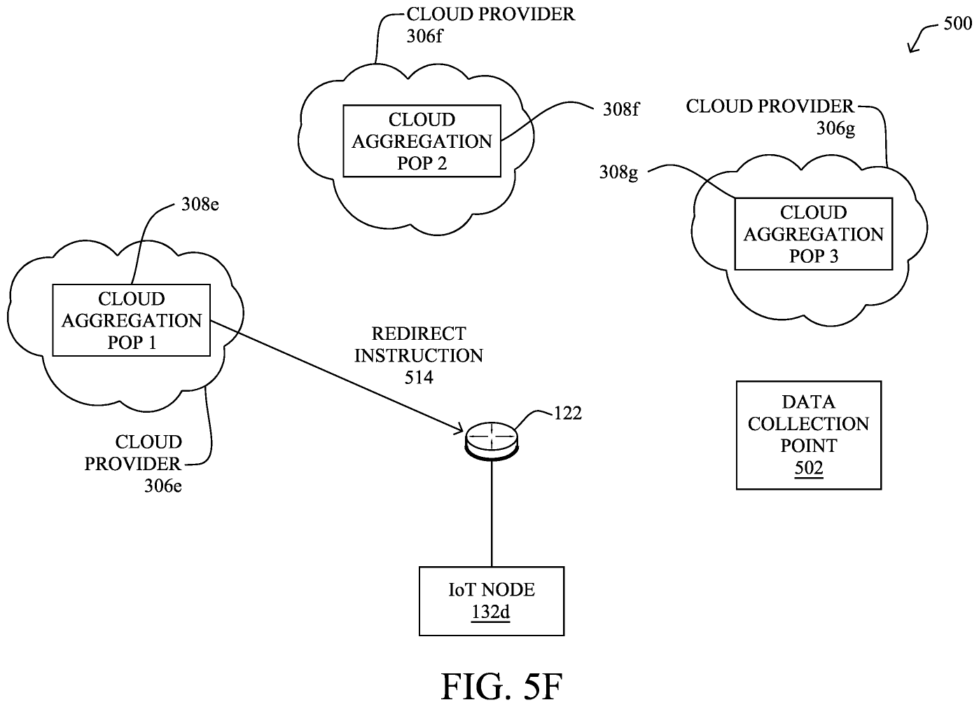

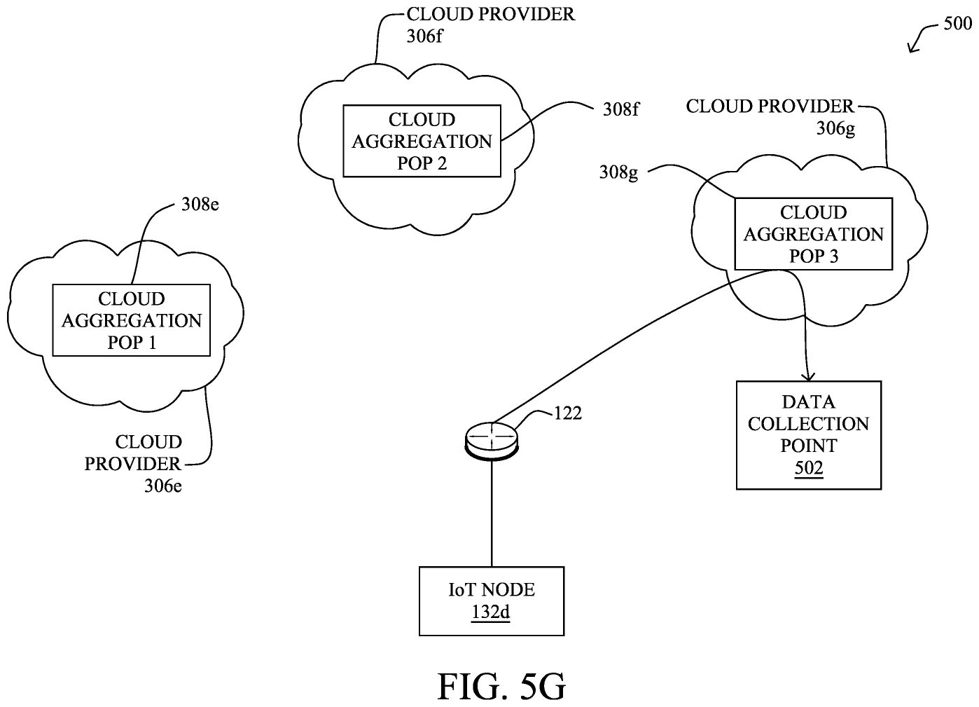

Operationally, FIGS. 5A-5G illustrates an example of the selection of a point of presence (POP), according to various embodiments. Continuing the previous examples, assume that there is an edge device 122 located at the edge of a network comprising any number of IoT nodes 132, such as IoT node 132d shown. Further, assume that there are a plurality of cloud-hosted POPs that aggregate data from the IoT network (e.g., sensor data from IoT node 132d, etc.). For instance, as shown, there may be a first cloud aggregation POP 308e hosted by a first cloud provider 306e, a second cloud aggregation POP 308f hosted by a first cloud provider 306f, and a third cloud aggregation POP 308g hosted by a third cloud provider 306g. In some instances, cloud providers 306e-306g may be separate cloud providers. However, in further cases, cloud providers 306e-306g may be associated with the same cloud provider (e.g., Amazon, Microsoft, etc.). Regardless, assume for purposes of illustration that each of POPs 308e-308g are located in different geographic locations (e.g., the U.S., Europe, Asia, etc.).

In various embodiments, POPs 308e-308g may comprise a data aggregation service and/or data brokering service, such as an MQTT broker, LoRaWAN network server, or the like. Thus, during operation, edge device 122 may publish data to a particular one of POPs 308e-308g sourced from an IoT node in the local IoT network, such as IoT node 132d (e.g., sensor data, operational data, etc.). In addition, edge device 122 may perform the various data ingestion, transformation, and/or governance functions described previously with respect to FIGS. 4A-4B.

As shown, there may also be a data collection point 502 to which the data from edge device 122 will ultimately be sent by the receiving POP. For instance, data collection point 502 may take the form of a data warehouse system and/or data analytics system that stores and/or analyzes the data sent by edge device 122. Examples of data collection point 502 may include, but are not limited to, a Hadoop, NoSQL, or Spark system in a data center, a Google machine learning service, or the like. In some instances, data collection point 502 may be a data center associated with the operator of the operator of the IoT network. In other cases, data collection point 502 may be another cloud service hosted somewhere on the Internet.

Today, POP selection by an IoT edge device is typically based on the distance between the edge device and the POP. In other words, the closest POP is typically the one to which an IoT edge device sends its traffic. For instance, assume that POP 308e is located in the U.S., POP 308f is located in Europe, and POP 308g is located in Asia. If edge device 122 is also located in the U.S., it may simply select POP 308e as its data aggregator. However, assume now that data collection point 502 is located in Japan. While POP 308e may be the closest POP to edge device 122 and, consequently, the path between them offers the shortest round-trip time (RTT), the overall RTT of the path extending from edge device 122 to POP 308e to data collection point 502 may be sub-optimal. Indeed, sending the IoT data to POP 308g may actually result in a shorter overall RTT to data collection point 502. Thus, an opportunity exists to optimize the POP selection process by taking into account the full end-to-end path metrics between the edge device and the data collection point.

According to various embodiments, the selection of the optimal POP for use by an IoT edge device may proceed as follows. First, the operator of the local IoT network may sign up for a data aggregation service, such as Cisco Asset Vision (based on LoRaWAN), Cisco Edge Intelligence, Amazon Web Services (AWS) IoT Core, Microsoft Azure IoT Hub, or the like. In general, these cloud services collect data, process it, and broker it to its final destination(s), where the operator of the IoT network may store, analyze, and visualize their data. In further embodiments, the operator of the IoT network may also specify POP preferences that can be used during the POP selection process. For instance, the operator may also specify a list of POPs that can be used, a list of one or more POPs to exclude, a preferred POP, or the like.

As part of the onboarding process with the data aggregation service, the operator may specify the final destination(s) of the data. In turn, when the operator on-boards an edge device to the data aggregation service, the edge device may first register with the closest POP of the aggregation service. For instance, assume that the operator of the IoT network in which IoT node 132d is located onboards edge device 122 to a data aggregation service associated with POPs 308e-308g. In such a case, edge device 122 may send a registration 504 to POP 308e, as it is the closest POP to edge device 122.

As shown in FIG. 5B, after receiving registration 504 from edge device 122, POP 308e may coordinate proving of the various paths available between edge device 122 and data collection point 502, according to various embodiments. To do so, POP 308e may instruct edge device 122 to send a registration request to all of the other POPs (e.g., POP 308f and POP 308g), or those POPs that were specified by preference by the operator of the IoT network, and to timestamp those packets. By timestamping the packets of the registration requests, the receiving POP can calculate metrics such as the round-trip time (RTT) between that POP and edge device 122. In other words, the initial POP 308e may send an instruction 506a to edge device 122 to probe the various path segments between itself and the POPs that are available to it.

In addition to instructing edge device 122 to probe its paths to POPs 308f-308g, POP 308e may also send an instruction 506b to data collection point 502 to probe its paths with POPs 306e-306g, likewise. Such a synthetic probe may also be timestamped by data collection point 502, to allow each receiving POP to compute the RTT and/or other path metrics for these path segments.

In various embodiments, POP 308e may also send instructions 508a-508b to POPs 306f-306g, respectively, that instructs these POPs to receive the incoming probes from edge device 122 and data collection point 502 and to return the results to POP 308e, when completed.

Thus, as shown in FIG. 5C, edge device 122 may perform probing 510a-510c of the paths between itself and POPs 308e-308g, or a subset thereof. Preferably, the probing of the other POPs 308f-308g may comprise registration requests that include the information needed to onboard edge device 122 to either of them. However, this is not a strict requirement and other forms of path probing may be used, in the alternate.

Similarly, as shown in FIG. 5D, data collection point 502 may also initiate its own probing 510d-510f of its respective paths to POPs 308e-308g. For instance, data collection point 502 may send timestamped packets to each of POPs 308e-308g.

As shown in FIG. 5E, in various embodiments, POPs 308f-308g may send the results 512a-512b of the probing to POP 308e. For instance, POP 308f may compute the RTT between itself and edge device 122, as well as between itself and data collection point 502, and include these metrics in results 512a. Similarly, POP 308g may compute the RTT between itself and edge device 122, as well as between itself and data collection point 502, and include these metrics in results 512. POP 308e may perform similar computations with respect to itself, edge device 122, and data collection point 502. In further embodiments, results 512a-512b may simply include the raw measurement data and POP 308e may perform the RTT computations, itself.

In further embodiments, results 512a-512b may also include any other path metrics that may be obtained from the probing performed in FIGS. 5C-5D and used for the POP selection. For instance, results 512a-512b may also include metrics such as latency, jitter, packet loss, minimum bandwidth or other bandwidth measurements, reliability metrics, or the like.

Computation of the end-to-end metrics for the paths between edge device 122 and data collection point 502 may simply entail combining the metrics for their constituent path metrics. For instance, the RTT between edge device 122 and data collection point 502 via POP 308e can be computed by summing the RTT of the path segment between POP 308e and edge device 122 with the path segment between POP 308e and data collection point 502. Similar computations may also be made with respect to the end-to-end paths that extend from edge device 122 to data collection point 502 via POPS 308f-308g. Other path metrics can be combined to form end-to-end path metrics, such as by taking an average of the metrics for the path segments, summing the metrics for the path segments, computing other aggregated statistics, or the like.

In various embodiments, POP 308e may select the optimal POP for edge device 122 to use, based on the results of the path probing. In one embodiment, POP 308e may simply provide the path metrics to a user interface for review by the operator of the IoT network and, in turn, receive a selection of the optimal POP or end-to-end path between edge device 122 and data collection point 502. In further embodiments, POP 308e may use the probing results as input to an objective function configured to select the preferred POP and end-to-end path. For instance, such an objective function may take into account the end-to-end RTT, latency, jitter, bandwidth, etc. Thus, POP 308e may generate a ranking of the top n-number of POPs for edge device 122 based on their associated end-to-end path metrics. In turn, POP 308e may simply select the top POP from the list or seek confirmation of the selection via the user interface, first.

Once the best POP 308e has identified the optimal POP for use by edge device 122, it may send a redirect instruction 514 to edge device 122, as shown in FIG. 5F. For instance, assume that POP 308g is selected as the optimal POP for edge device 122. In such a case, redirect instruction 514 may instruct edge device 122 to send its traffic data to POP 308g. In response, as shown in FIG. 5G, edge device 122 may move its tunnel termination to POP 308g, thereby switching its end-to-end path with data collection point 502 to the path that extends via POP 308g.

Note that, in some cases, the initial POP (e.g., POP 308e) may be the optimal POP for edge device 122. When this occurs, POP 308e may send a confirmation to edge device 122 that it should continue to use POP 308e. Alternatively, POP 308e may simply omit sending such a notification or a redirect instruction 514 to edge device 122, allowing edge device 122 to continue using POP 308e.

When a different POP is selected for use by edge device 122, the initial POP may also replicate its probe database with the results of the path probing to the selected POP. This allows the selected POP to continue to monitor the end-to-end path metrics of the current path between edge device 122 and data collection point 502 and, if necessary, select an alternate path. For instance, if the performance of the end-to-end path between edge device 122 and data collection point 502 via POP 308g degrades, POP 308g may send a redirect instruction to edge device 122 for the next best POP, according to the probing results. In further embodiments, POP 308g may also initiate new probing of each end-to-end path, such as when the existing probing results reach a threshold age and are considered stale.

Note that while the probing coordination and POP selection are shown in FIGS. 5A-5G as being performed by POP 308e, any device associated with POP 308e may perform these functions, either directly as a part of POP 308e or in communication therewith.

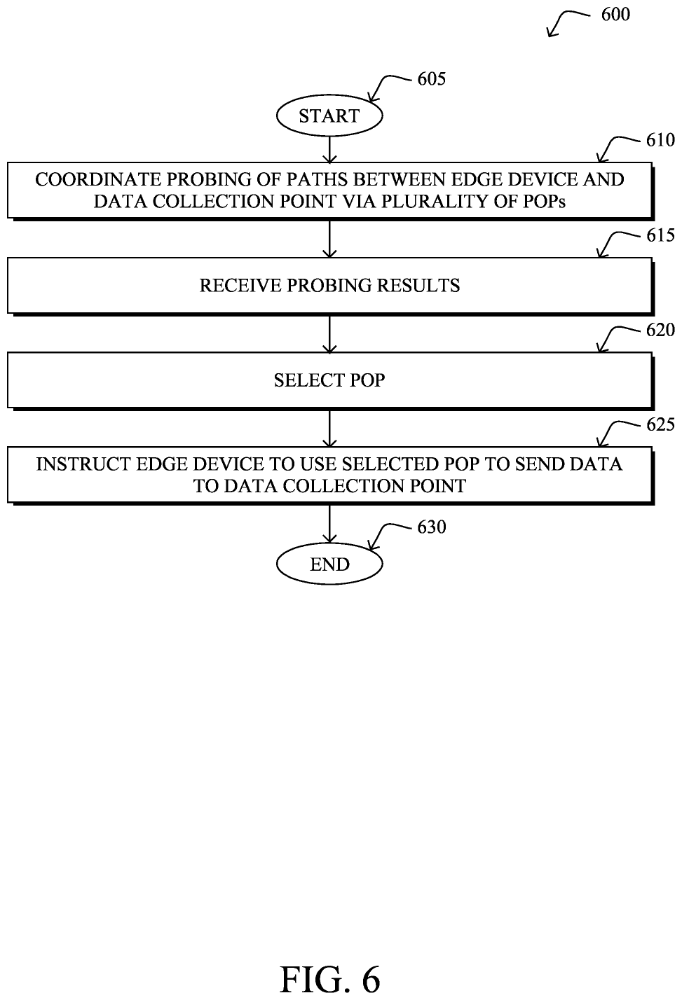

FIG. 6 illustrates an example simplified procedure for selecting an optimal POP, in accordance with one or more embodiments described herein. The procedure 600 may start at step 605, and continues to step 610, where, as described in greater detail above, a specifically-configured, first device (e.g., device 200) may coordinate probing of network paths that extend between an edge device and a data collection point via a plurality of points of presence (POPs). For instance, in some embodiments, the first device may is itself be associated with one of the POPs. In such cases, the first device may coordinate the probing, after receiving a registration request from the edge device. Typically, the edge device is a router or other networking device at the edge of an IoT network. In various embodiments, the first device may coordinate the probing by any or all of the following: instructing the edge device to send probes to the plurality of POPs, instructing the data collection points to send probes to the plurality of POPs, and/or notifying the POPs to expect probes.

At step 615, as detailed above, the first device may receive a set of probing results that are indicative of one or more performance metrics associated with the network paths. For instance, the probing results may be indicative of the round-trip times (RTTs), latency, jitter, bandwidth, other measures of reliability, combinations thereof, or the like. In some embodiments, the first device may receive at least a portion of the set of probing results from one or more of the plurality of POPs. In further embodiments, the set of probing results comprises a first subset of probing results associated with path segments between the edge device and the plurality of points of presence and a second subset of probing results associated with path segments between the data collection point and the plurality of points of presence.

At step 620, the first device may select, based on the set of probing results, a particular POP from among the plurality of POPs through which the edge device should send traffic to the data collection point, as described in greater detail above. For instance, the first device may select a particular cloud-based data aggregation service or cloud-based brokering service (e.g., an MQTT broker, a LoRaWAN network server, etc.) to which the edge device should send its data, based on the performance associated with the path extending from the edge device to the data collection point via that POP. In a simple case, the first device may simply select the POP based on the RTT associated with its corresponding path. However, in more complex implementations, the optimization may entail optimizing an objective function that takes into account a plurality of path metrics (e.g., latency, jitter, etc.). In further cases, the first device may also filter out any POPs from consideration whose paths exhibit one or more characteristics that exceed a predefined threshold (e.g., number of packet drops, etc.).

At step 625, as detailed above, the first device may instruct the edge device to send traffic to the data collection point via the particular POP. In turn, the edge device may send its traffic, such as data from any number of IoT devices in the IoT network, to the data collection point via the optimal POP. Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for the optimal selection of a cloud-based POP to which an edge device should send traffic, by also taking into account the data collection point that serves as the final destination of the data in the traffic.

While there have been shown and described illustrative embodiments for the optimal selection of a cloud-based data management service for IoT sensors, it is to be understood that various other adaptations and modifications may be made within the intent and scope of the embodiments herein. For example, while specific protocols are used herein for illustrative purposes, other protocols and protocol connectors could be used with the techniques herein, as desired. Further, while the techniques herein are described as being performed by certain locations within a network, the techniques herein could also be performed at other locations, such as at one or more locations fully within the local network (e.g., by the edge device), etc.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable is medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

1. A method comprising:
coordinating, by a first device, probing of network paths that extend between an edge device and a data collection point via a plurality of points of presence;
receiving, at the first device, a set of probing results that are indicative of one or more performance metrics associated with the network paths;
selecting, by the first device and based on the set of probing results, a particular point of presence from among the plurality of points of presence through which the edge device should send traffic to the data collection point; and
instructing, by the first device, the edge device to send traffic to the data collection point via the particular point of presence.

2. The method as in claim 1, wherein the one or more performance metrics are indicative of round-trip times between the edge device and the data collection point via the plurality of points of presence.

3. The method as in claim 1, wherein the first device is associated with one of the plurality of points of presence.

4. The method as in claim 3, further comprising:
receiving, at the first device, a registration request from the edge device.

5. The method as in claim 1, wherein coordinating probing of the network paths that extend between the edge device and the data collection point via a plurality of points of presence comprises:
instructing the edge device to send probes to the plurality of points of presence.

6. The method as in claim 1, wherein coordinating probing of the network paths that extend between the edge device and the data collection point via a plurality of points of presence comprises:
instructing the data collection point to send probes to the plurality of points of presence.

7. The method as in claim 1, wherein the first device receives at least a portion of the set of probing results from one or more of the plurality of points of presence.

8. The method as in claim 1, wherein one or more of the plurality of points of presence comprise a cloud-based data aggregation service or cloud-based brokering service.

9. The method as in claim 8, wherein the cloud-based data aggregation service or cloud-based brokering service comprises a Message Queueing Telemetry Transport (MQTT) broker or a LoRaWAN network server.

10. The method as in claim 1, wherein the set of probing results comprises a first subset of probing results associated with path segments between the edge device and the plurality of points of presence and a second subset of probing results associated with path segments between the data collection point and the plurality of points of presence.

11. An apparatus, comprising:
one or more network interfaces;
a processor coupled to the one or more network interfaces and configured to execute one or more processes; and
a memory configured to store a process that is executable by the processor, the process when executed configured to:
coordinate probing of network paths that extend between an edge device and a data collection point via a plurality of points of presence;
receive a set of probing results that are indicative of one or more performance metrics associated with the network paths;
select, based on the set of probing results, a particular point of presence from among the plurality of points of presence through which the edge device should send traffic to the data collection point; and
instruct the edge device to send traffic to the data collection point via the particular point of presence.

12. The apparatus as in claim 11, wherein the one or more performance metrics are indicative of round-trip times between the edge device and the data collection point via the plurality of points of presence.

13. The apparatus as in claim 11, wherein the apparatus is associated with one of the plurality of points of presence.

14. The apparatus as in claim 13, wherein the process when executed is further configured to:
receive a registration request from the edge device.

15. The apparatus as in claim 11, wherein the apparatus is configured to coordinate probing of the network paths that extend between the edge device and the data collection point via a plurality of points of presence by:
instructing the edge device to send probes to the plurality of points of presence.

16. The apparatus as in claim 11, wherein the apparatus is configured to coordinate probing of the network paths that extend between the edge device and the data collection point via a plurality of points of presence comprises:
instructing the data collection point to send probes to the plurality of points of presence.

17. The apparatus as in claim 11, wherein the apparatus receives at least a portion of the set of probing results from one or more of the plurality of points of presence.

18. The apparatus as in claim 11, wherein one or more of the plurality of points of presence comprise a cloud-based data aggregation service or cloud-based brokering service.

19. The apparatus as in claim 11, wherein the set of probing results comprises a first subset of probing results associated with path segments between the edge device and the plurality of points of presence and a second subset of probing results associated with path segments between the data collection point and the plurality of points of presence.

20. A tangible, non-transitory, computer-readable medium storing program instructions that cause a first device to execute a process comprising:
coordinating, by the first device, probing of network paths that extend between an edge device and a data collection point via a plurality of points of presence;
receiving, at the first device, a set of probing results that are indicative of one or more performance metrics associated with the network paths;
selecting, by the first device and based on the set of probing results, a particular point of presence from among the plurality of points of presence through which the edge device should send traffic to the data collection point; and
instructing, by the first device, the edge device to send traffic to the data collection point via the particular point of presence.
